(19) United States
(12) Patent Application Publication
(10) Pub. No.: US 2010/0287069 A1
(43) Pub. Date: Nov. 11, 2010

(54) SYSTEM AND METHOD TO GUARANTEE A SELLING PRICE OF A PRODUCT

(75) Inventors: William N. Hudak, Palo Alto, CA (US); Jordan Kobert, San Francisco, CA (US)

Correspondence Address: Jordan Kobert, 262 Frederick St., #1, San Francisco, CA, 94117, US

(73) Assignee: Thintail, Inc., Palo Alto, CA (US)

(21) Appl. No.: 12/756,155

(22) Filed: Apr. 7, 2010

Related U.S. Application Data
(63) Continuation-in-part of application No. 12/459,302, filed on Jun. 30, 2009.
(60) Provisional application No. 61/076,995, filed on Jun. 30, 2008.
(60) Provisional application No. 61/234,572, filed on Aug. 17, 2009.
(60) Provisional application No. 61/212,196, filed on Apr. 7, 2009.

(51) Int. Cl. G06Q 30/00; G06Q 40/00

(52) U.S. Cl. 705/27; 705/39; 705/400

(57) ABSTRACT

A preferred method for providing a guarantee for a value of product includes the steps of receiving product information, generating a product value based on the received product information, and providing a guarantee that a user will receive a payment for a product, the payment having a value at least equal to the generated product value. A preferred system for generating a product value includes a user interface adapted and configured to receive product information; a processor coupled to the user interface, wherein the processor is adapted and configured to generate a product value based on the product information received by the user interface; and a payment having a value at least equal to the product value. The system and method are preferably designed for the ecommerce field and, more specifically, for guaranteeing a selling price of a product in the ecommerce field.

### CROSS-REFERENCE TO RELATED APPLICATIONS

This application claims priority to U.S. Provisional Application No. 61/212,196, titled “SYSTEM AND METHOD TO GUARANTEE A SELLING PRICE OF A PRODUCT” filed Apr. 7, 2009, which is incorporated by reference herein in its entirety. This application also claims priority to U.S. Provisional Application No. 61/234,572, titled “SYSTEM AND METHOD TO GUARANTEE A SELLING PRICE OF A PRODUCT” filed Aug. 17, 2009, which is incorporated by reference herein in its entirety. This application is a Continuation-in-part to U.S. application Ser. No. 12/459,302, titled “SYSTEM AND METHOD TO GUARANTEE A SELLING PRICE OF A PRODUCT”, filed Jun. 30, 2009, which is a Non-provisional application of U.S. Provisional Application No. 61/076,995, titled “SYSTEM AND METHOD TO GUARANTEE A SELLING PRICE OF A PRODUCT” filed Jun. 30, 2008. Each of these applications is incorporated by reference herein in its entirety.

In addition, the systems and methods described herein may be applied to any of the devices and systems described in any of the following references. This application may be related to U.S. application Ser. No. 11/682,278, titled “System and Method for Enabling Online Research, Publication, Promotion, and Management of User Goods”, and filed Mar. 5, 2007. This application may also be related to U.S. application Ser. No. 12/387,446, titled “Systems and Methods to Generate a Product Value”, filed May 1, 2009. Each of these applications is incorporated by reference herein in its entirety.

### INCORPORATION BY REFERENCE

All publications and patent applications mentioned in this specification are herein incorporated by reference in their entirety as if each individual publication or patent application was specifically and individually indicated to be incorporated by reference.

### TECHNICAL FIELD

This invention relates generally to the ecommerce field, and more specifically to an improved method and system to guarantee a selling price of a product in the ecommerce field.

### BRIEF DESCRIPTION OF THE FIGURES

FIG. 1 is a flow diagram of the system and method of a preferred embodiment of the invention.

FIG. 2 is a flow diagram of the step of receiving product information of the system and method of a preferred embodiment of the invention.

FIGS. 3 and 4 are flow diagrams of the system and method of a preferred embodiment of the invention.

FIG. 5 is a flow diagram of purchasing a product.

FIG. 6 is a flow diagram of a transaction authentication.

FIG. 7 is a flow diagram of receiving a selling price guarantee for a product and selling a product.

### DESCRIPTION OF THE PREFERRED EMBODIMENTS

The following description of preferred embodiments of the invention is not intended to limit the invention to these embodiments, but rather to enable any person skilled in the art to make and use this invention.

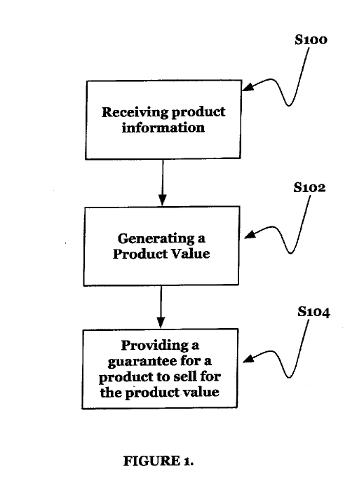

As shown in FIG. 1, the system and method of the preferred embodiments includes the steps of receiving product information S100, generating a product value S102, and providing a guarantee for the product to sell for the product value S104. The system is preferably designed for the e-commerce field and, more specifically, for guaranteeing a selling price of a product in the e-commerce field. The system, however, may be alternatively used in any suitable environment and for any suitable reason.

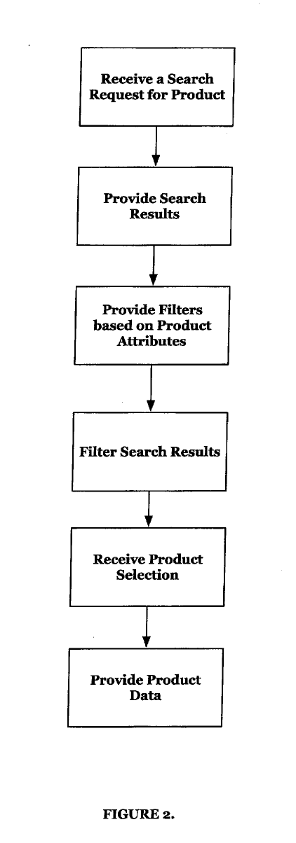

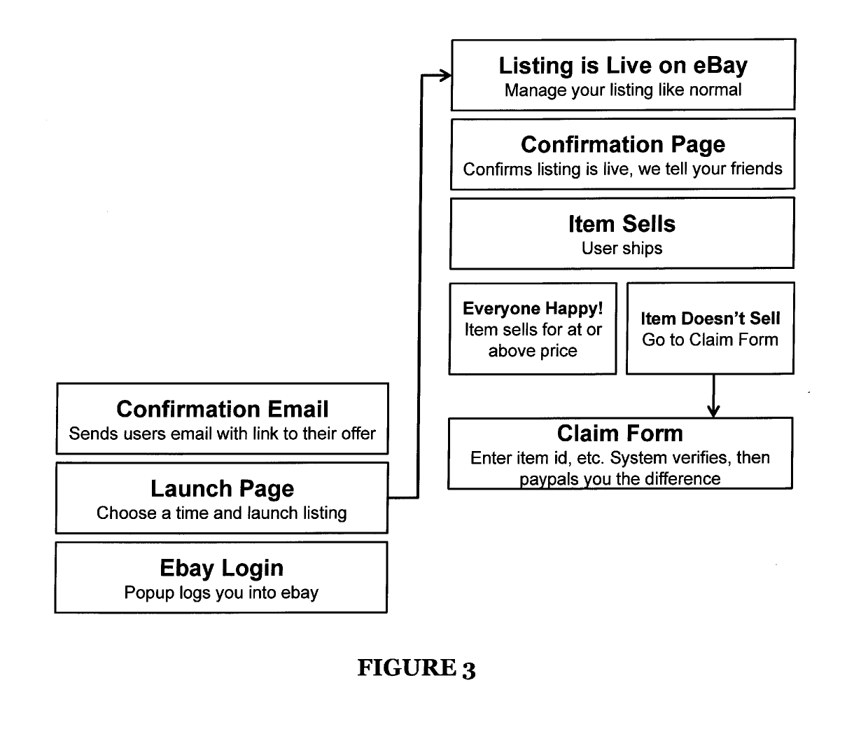

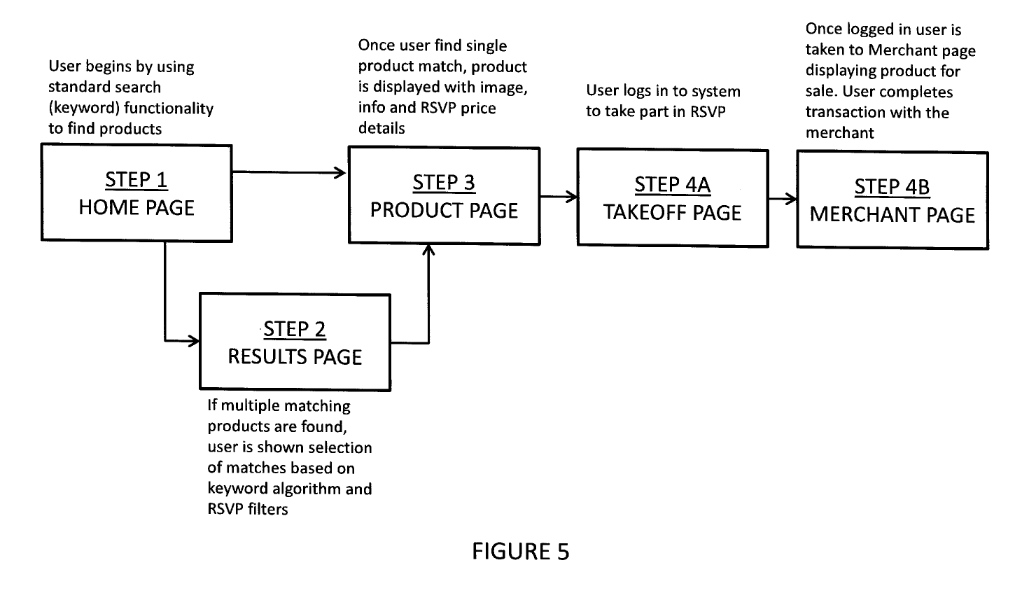

The step of receiving product information S100 functions to indicate to the system, the product for which the system will generate a product value and for which the user wishes to obtain a guarantee. The product information is preferably received in one of several variations. In a first variation, as shown in FIG. 2 and in step 1 of FIG. 5, the step of receiving product information S100 includes any suitable combination of the steps of receiving a search request for a product, providing search results, providing filters based on product attributes, receiving filtered search results, receiving a product selection, and providing product data. The step of receiving a search request for a product includes the steps of receiving a product description into a search bar and receiving a search request. For example, a user preferably enters keywords (such as specific product attributes) for a product for which they wish to search (and preferably eventually buy and/or sell) and then initiates the search. The user may alternatively enter categories and subcategories to “narrow in” on the desired product. The step of providing search results preferably includes the step of providing a list of relevant products.

Step 2 of FIG. 5 illustrates a “results page”, i.e. a listing of the relevant products. The list of relevant products may also include a photo of each product and/or a brief description and/or title of the product. The search results may be filtered based on the attributes of the products. Product attributes preferably include brand, model, size, storage capacity, mega pixels, etc. A user may select a specific product from the list of search results. The system preferably provides product data on this product such as average price, price of the item when new, where to buy the buy product, where to buy the item on internet marketplaces such as eBay, product specifications, product reviews, the values of other users' similar products, and/or any other suitable information.

In a second variation, the step of receiving product information S100 is completed from scratch by a user entering information on the product directly or may be completed by a user customizing a product selected from the product search results. The step of receiving product information S100 preferably includes the steps of receiving the title of the product, receiving a description of the product, and/or receiving uploaded photos of the product. The step of receiving a description of the product includes receiving information on the model of the product, accessories or extras included with the product, and/or any other suitable information on the product.

In some embodiments, the step of providing a list of relevant products includes the steps of receiving data from an entity, editing the received data, and providing a list of products. The step of receiving data from an entity includes receiving data from an entity such as a merchant or retailer, more specifically such as an online merchant or online retailer. The data received from the entity may include a list of products sold by the entity, specifications of the products, photographs of the products, selling price of the product, or other suitable data. The step of editing the data received may include the step of generating a set of rules or criteria for the data and applying those rules or criteria to the data to edit the data received. The rules and/or the criteria may be used to sort, edit, delete, etc. some portion of the data. The rules and/or the criteria may include a list of products, and/or product criteria such as “product type” (i.e. digital camera, MP3 player, etc.), “brand name” (i.e. Sony, Cannon, Apple, etc.), or “price range” (i.e. $100-$500 dollars). The data is preferably edited, or “scrubbed”, to include only products for which a product value and/or a guaranteed product value may be generated.

For example, data received from an entity may include data about printers (color printers, laser printers, etc.) and also include data about printer ink cartridges (blue ink cartridges, yellow ink cartridges, black ink cartridges, etc.). In this example, it may be suitable to guarantee a selling price for a printer, but not for an ink cartridge. Therefore, the step of editing the date received in this example may include removing the data for the printer ink cartridges. Furthermore, the step of providing a list of relevant products in this example would include providing a list of printers, while not proving a list of ink cartridges from the entity.

In some embodiments, as shown in step 3 of FIG. 5, once the user has identified a product, the product is displayed. The user preferably identifies a product that sufficiently fits their search criteria, that they wish to purchase, and/or that they wish to receive a guaranteed product value. The product may be displayed with a product photo, product specifications, and/or with the generated product value. In some embodiments, the price offered by a merchant or other suitable entity may be displayed in addition to the generated product value (the price for which the user will receive the guarantee).

The step of generating a product value S102, functions to provide a value for which the system and method will provide the guarantee. The product value is preferably generated in one of several variations. In a first variation, the step of generating a product value S102 preferably includes the steps of receiving information from multiple sources, removing outlying values, assigning weights to values, generating an average value, and generating a product value S102. Multiple sources from which information is received preferably include user estimated values, marketplace listings (such as Ebay, Amazon, or Craigslist), retailer or manufacturers, or any other suitable source of information. The step of removing outlying values functions to remove unreasonable and/or incorrect values from the information gathered from at least one source before they are included in the generation of the product value. An outlying value is a value that is either too low or too high to be included in the generation of the product value. The step of assigning weights to values functions to differentiate between different values received from the information gathered from at least one source and to assign a higher weight to some values and a lower weight to other values. Values assigned a higher weight will play a larger role in the generation of the product value than a value that has been assigned a lower weight. Once the outliers have been removed and the weightings have been assigned, an average value is generated taking into account all (or any suitable combination) of the considerations described above. The weighted average values are then preferably combined in any suitable fashion to generate the product value. The first variation of the step of generating a product value S102 is preferably performed for the product that the system will provide the guarantee, but may alternatively be performed for a similar product or for a product in a similar product category or for any other suitable product.

Although the step of generating a product value S102 is preferably completed using any suitable combination of steps as described above, the product value may alternatively be generated using a fixed value for a given product, using a fixed value for a given product in a given condition, using a percentage of a new value for a given product, using a percentage of any other suitable value for a given product, or any other suitable number, percentage, or value. Additionally, the user may determine the product value directly.

The step of providing a guarantee for the product to sell for the product value S104 (herein known as “providing a guarantee”), functions to guarantee that a user will receive the generated product value when the product is sold. This will preferably occur by (a) a user obtaining an actual sale price that is equal to or greater than the generated product value or (b) a user obtaining an actual sale price is less than the generated product value, and receiving from the system the difference between the generated product value and the actual sale price.

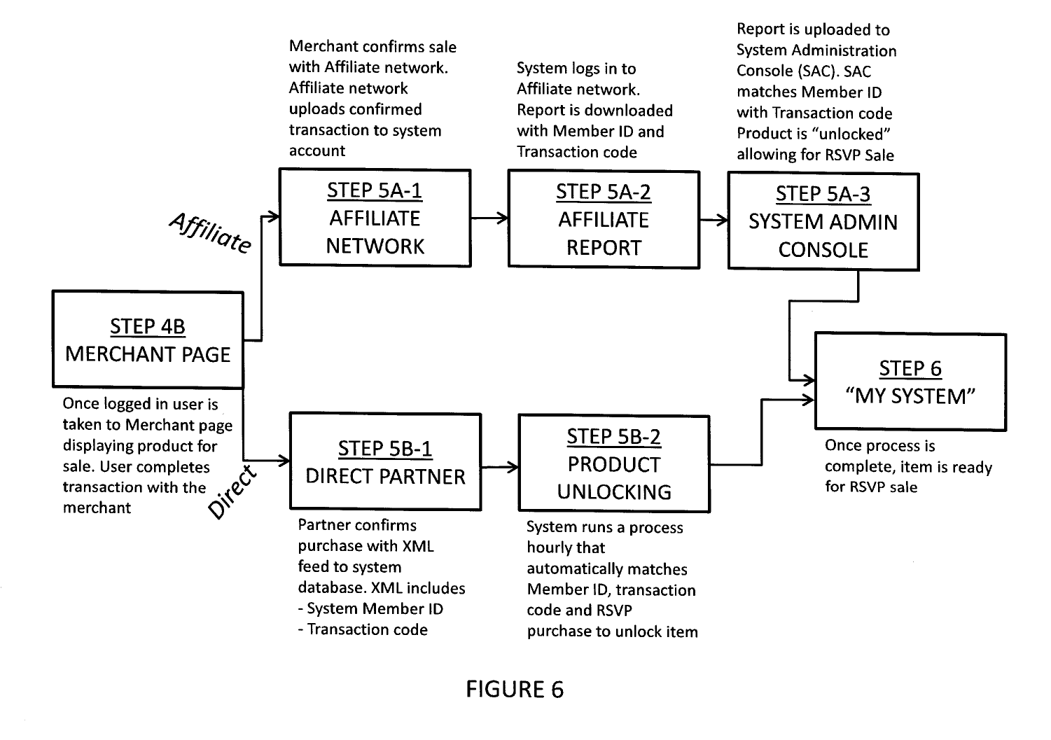

As shown in steps 4A and 4B of FIG. 5, a user will preferably obtain this guarantee by buying the product for which the guarantee was generated. The purchase transaction may be authenticated by one of several methods. As shown in FIG. 6, a first example includes the steps of (5A-1) the merchant confirming the sale of the product with an affiliate network, (5A-2) affiliate network confirms the sale, and (5A-3) providing the guarantee to the user. A second example includes the steps of (5B-1) the merchant may be a direct partner and directly confirms the sale of the product and (5B-2) providing the guarantee to the user. As shown in step 6 of FIG. 6, once the guarantee is provided to the user, the user may then initiate the sale of their purchased product.

The user may alternatively obtain the guarantee in any other suitable fashion such as by performing an action like purchasing a subscription or by purchasing the guarantee directly. The user may purchase this guarantee by paying a fixed price, a percentage of the product value, a percentage of the actual sale price, or by paying any other suitable price. The guarantee is preferably for the product to sell for the generated product value that has been provided by the system. However, a user may purchase a guarantee for any suitable price based on any suitable value for the product, generated by any suitable system and/or generated or chosen by the user.

The user may additionally opt to upgrade the generated guarantee. An upgrade may include increasing the dollar amount of the guarantee, increasing the length of time the guarantee is valid (i.e. delaying the expiration of the guarantee), having the guarantee apply to multiple products, or any other suitable upgrade. The user may obtain an upgraded guarantee by purchasing the upgrade, or alternatively by performing an action such as purchasing a new product or subscription, purchasing a product from a specific merchant, selling the product using a specific tool, product, and/or with a specific entity, or by any other suitable method.

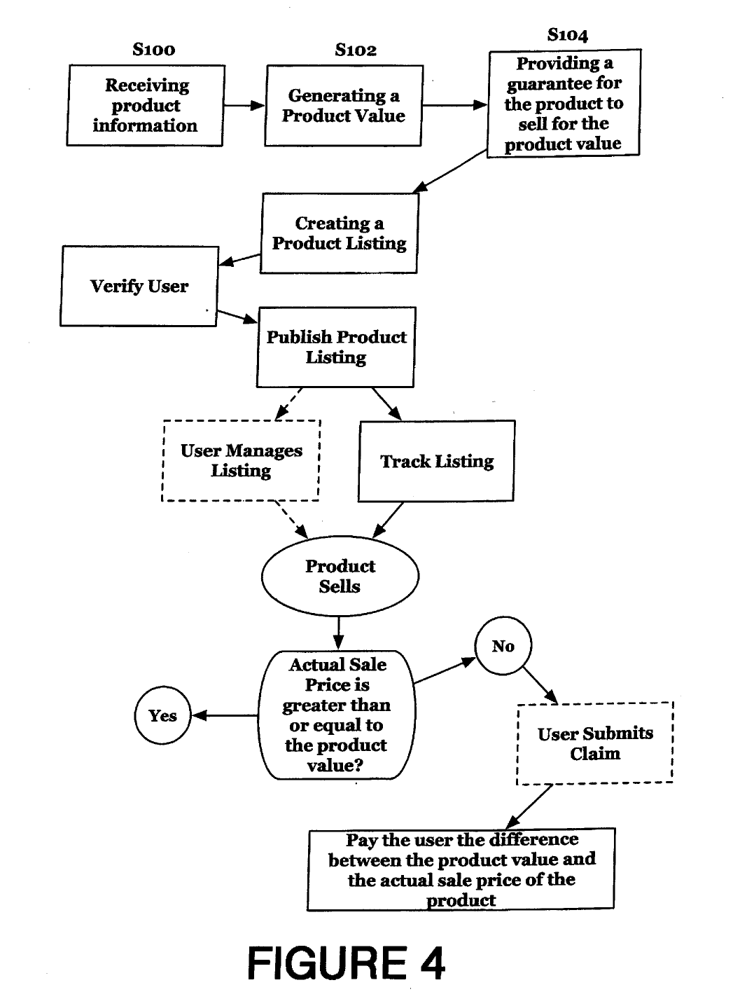

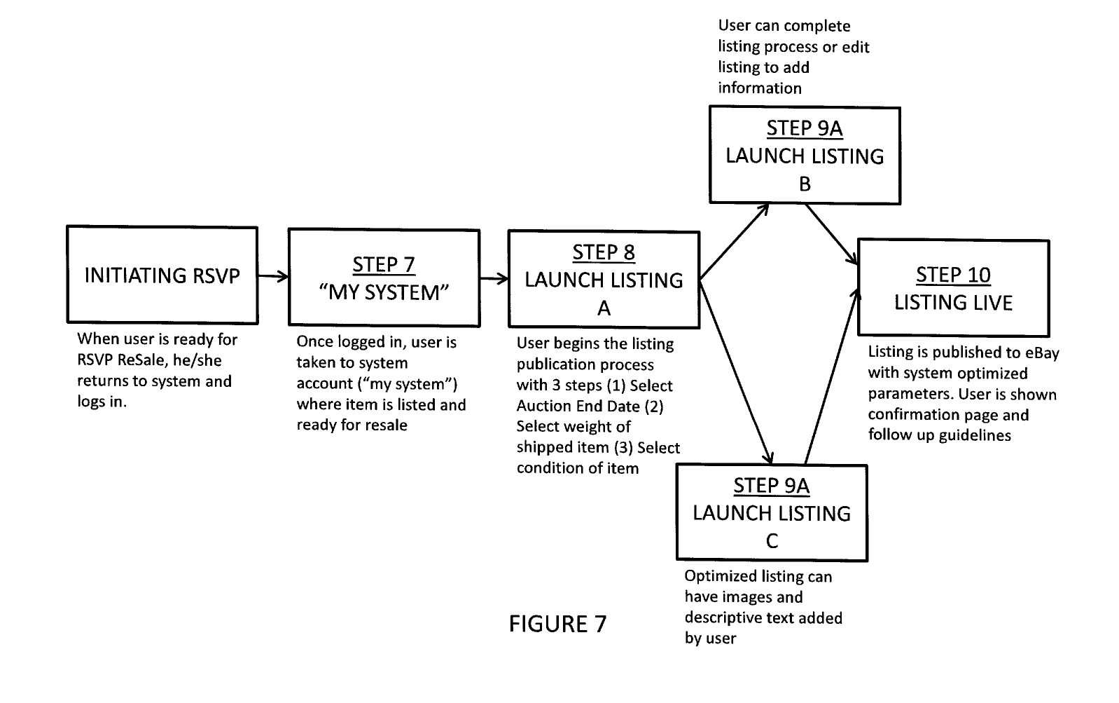

As shown in FIGS. 4 and 7, once the user has obtained the guarantee for their product to sell at the generated product value, the user will receive the difference between the generated product value and the actual sale price upon selling their product, if the actual sale price is less than the generated product value. For example, a user may be selling a cellular phone, the generated product value is $120.00, and the user has obtained the guarantee for their product to sell for the product value. In this example, if the user sells their cellular phone for the actual selling price of $105.00. The user will receive, from the system, the difference between the generated product value and the actual sale price, which is $15.00 ($120.00−$105.00=$15.00). In some situations it is possible that the user will sell their cellular phone for the actual selling price of $105.00 but the buyer of the product does not or refuses to pay the user the full actual selling price. In this situation, the system will preferably provide difference between the generated product value and the actual sale price ($15.00), independent of the amount of money that the buyer actually pays the user. Alternatively, the system may provide the difference between the generated product value and the actual amount of money that the user receives. For example, if the user sells the cellular phone for the actual sale price of $105.00, but the buyer does not actually pay the user, the system may provide the difference between the generated product value and the amount of money that the user actually receives ($0.00). In this example, this difference is $120.00 ($120.00−$0.00=$120.00).

The guarantee preferably includes conditions that must be met in order for the user to receive the difference between the generated product value and the actual sale price. The conditions preferably include any suitable combination of conditions including specifying the condition of the product to be sold, specifying where the listing for the product is created, where the listing for the product is published, when and for how long the listing for the product is active, when the guarantee will expire, or any other suitable conditions.

As shown in FIG. 4, the system and method of the preferred embodiments may also include any suitable combination of the steps of creating a product listing, verifying a user identity, tracking the product listing, a user monitoring the product listing, promoting a product listing (not shown), a user submitting a claim, and paying the difference between the product value and the actual sale price of the product. The step of creating a product listing functions to allow a user to easily sell their product. The system preferably provides a mechanism with which a user may easily create a product listing with which to sell their item in a marketplace, such as eBay, or in any other suitable location. The product listing is preferably created using the received information on the product, such as model, condition, accessories, etc. Once the product listing has been created, the step of verifying a user identity is preferably performed. This step is preferably performed by (a) requiring a user to log into a system, (b) sending the user an email and requiring that they use a link within the email to access their product listing, and/or (c) through any other suitable mechanism. When the user accesses their product listing via a link in an email received from the system, the user is preferably able to edit and preview their listing. Alternatively, the user may edit and preview their listing at any other suitable time through any other suitable mechanism.

As shown in FIG. 4, preferably once the product listing has been created and the identity of the user has been verified, the product listing is published. The product listing is preferably published to a marketplace, such as eBay, but may alternatively be published in any other suitable location. Once created and verified, the product listing is preferably published by the system to the external marketplace, but alternatively, the product listing may be created externally, the identity of the user may not be verified, and/or the product listing may be published by a separate and/or external system.

As shown in FIG. 4, once the product listing is published the system then preferably performs the steps of tracking the product listing while a user performs the steps of monitoring the product listing. The system preferably tracks the system through an application program interface (API), but may alternatively track the product listing through any other suitable mechanism. The system preferably tracks the listing and monitors information such as time remaining for the listing, current sale price of the product, number of bids on the products, actual sale price of the product, and/or any other suitable information. The user preferably monitors the product listing according to the marketplace with which the product listing is published, but may alternatively monitor the product listing in any other suitable fashion. Alternatively, the user may fail to publish the listing and/or may fail to monitor the listing once the product listing is published.

The step of promoting a product listing functions to increase traffic to the published listing and preferably functions to increase the actual sale price of the product. The system preferably promotes the product listing by generating a widget or advertisement that can be published to external sites. The promotion on the external site is preferably an e-mail, a widget, or any other suitable promotion on any suitable external site. The external site is preferably a blog, social networking page such as Facebook, MySpace, and/or Bebo, a classifieds site such as Craigslist, or any other suitable external site. Alternatively, the published product listing can be promoted in any other suitable fashion.

As shown in FIG. 4, the product will preferably be sold through the product listing. The product will sell for an “actual sale price”. If the actual sale price is greater than or equal to the price at which the guarantee was applied (preferably the generated product value), then the user preferably receives the actual sale price from the buyer of the product, according to the rules, conditions, and/or specifications of marketplace with which the product listing is published. The user may alternatively receive the actual sale price (or nothing or any portion thereof) in any other suitable fashion. As shown in FIG. 4, if the actual sale price is less than the price at which the guarantee was applied (preferably the generated product value), then the user preferably receives the actual sale price, as described above, and additionally has the opportunity to receive the difference between the price at which the guarantee was applied (preferably the generated product value) and the actual sale price, which sums to the generated product value.

As shown in FIG. 4, if the actual sale price is less than the price at which the guarantee was applied then the step of a user submitting a claim is preferably performed. This step functions to submit a request to the system for a payment of the difference between the price at which the guarantee was applied (preferably the generated product value) and the actual sale price, which sums to the generated product value. Preferably, the payment will only be sent if the user meets the conditions of the guarantee as described above and/or if the system has received a claim for the payment. Alternatively, the system may automatically send a payment upon the sale of the product and/or upon the close of the product listing for the amount of the difference between the price at which the guarantee was applied and the actual sale price, if the actual sale price is less than the price at which the guarantee was applied. The system preferably sends the payment through any suitable system that allows payments and money transfers to be made through the Internet, such as Paypal, but may alternatively send a check, money order, add money to a credit card, provide credit or a gift certificate, or send the payment through any other suitable method.

Although omitted for conciseness, the preferred embodiments include every combination and permutation of the various steps of receiving product information S100, generating a product value S102, and providing a guarantee for a product to sell for that product value.

As a person skilled in the art will recognize from the previous detailed description and from the figures and claims, modifications and changes can be made to the preferred embodiments of the invention without departing from the scope of this invention defined in the following claims.

1. A method for providing a guarantee for a value of product, the method comprising:
receiving product information;
generating a product value based on the received product information; and
providing a guarantee that a user will receive a payment for a product, the payment having a value at least equal to the generated product value.

2. The method of claim 1, the receiving step comprising receiving a product value request from a user by the user selecting a product from a list of search results.

3. The method of claim 1, the receiving step comprising receiving the condition of the product.

4. The method of claim 3, the receiving step further comprising a rating of the condition of the product as determined by a user.

5. The method of claim 1, the generating step comprising accumulating product value information.

6. The method of claim 5, the accumulating step comprising receiving a value from an external site.

7. The method of claim 1, the generating step further comprising generating a product value by selecting a fixed value for a given product.

8. The method of claim 7, the generating step further comprising generating a product value by selecting a fixed value for a given product in a given condition.

9. The method of claim 1, the generating step further comprising generating a product value by calculating a percentage of the market value of the given product.

10. The method of claim 1, the generating step further comprising receiving the product value as an input from a user.

11. The method of claim 1, the providing step comprising providing a payment having a value equal to the difference between the generated product value and an actual sale price, wherein a user sells a product for the actual sale price and the actual sale price is less than the generated product value.

12. The method of claim 1, the providing step comprising providing a supplemental payment having a value equal to the difference between the generated product value and a payment received by a user in exchange for a product if the payment is less than the generated product value.

13. The method of claim 1, the providing step comprising providing a payment having a value equal to the generated product value.

14. The method of claim 1, further comprising the step of receiving a payment from a user for the guarantee.

15. The method of claim 1, the providing step further comprising providing a guarantee to a user for a given product, wherein the user has purchased a specified product.

16. The method of claim 1, further comprising the step of creating a product listing and publishing the product listing to a marketplace.

17. The method of claim 16, further comprising the step of receiving an actual sale price for the product.

18. The method of claim 17, further comprising providing a payment having a value equal to the difference between the generated product value and the actual sale price if the generated product value is greater than the actual sale price.

19. The method of claim 1, the providing step comprising providing a payment in the form of at least one of a money transfer, a check, a money order, credit, and a gift certificate.

20. A system for generating a product value, the method comprising:
a user interface adapted and configured to receive product information;
a processor coupled to the user interface, wherein the processor is adapted and configured to generate a product value based on the product information received by the user interface; and
a payment having a value at least equal to the product value.
